(19) United States
(12) Patent Application Publication
(10) Pub. No.: US 2013/0214019 A1
(43) Pub. Date: Aug. 22, 2013

(54) BICYCLE/MOTORCYCLE MOBILE ELECTRONIC DEVICE HOLDER

(71) Applicant: FU-CHI WU, NORTHRIDGE, CA (US)

(72) Inventor: FU-CHI WU, NORTHRIDGE, CA (US)

(21) Appl. No.: 13/400,789

(22) Filed: Feb. 21, 2012

(51) Int. Cl. B62J 11/00

(52) U.S. Cl. 224/413; 224/412

(57) ABSTRACT

A bicycle/motorcycle mobile electronic device holder includes a mobile electronic device carrier for holding a smart phone or tablet PC for navigation or predetermined purposes, a fastening unit consisting of fastening belts and hook and loop material pads for fastening the mobile electronic device carrier to the handlebars of a bicycle/motorcycle or the oil tank of a motorcycle, and a flexible and shock-absorptive anti-slip layer fixedly arranged at the bottom side of each fastening belt for direct contact with the surface of the handlebars of the bicycle/motorcycle or the oil tank of the motorcycle in which the fastening unit is installed.

### BACKGROUND OF THE INVENTION

1. Field of the Invention

The present invention relates to a device for holding a mobile electronic device, for example, smart phone, on a bicycle or motorcycle and more particularly, to a bicycle/motorcycle mobile electronic device holder, which comprises a mobile electronic device carrier for holding a mobile electronic device, such as smart phone or tablet PC, for navigation or predetermined purposes, a fastening unit consisting of fastening belts and hook and loop material pads for fastening the mobile electronic device carrier to the handlebars of a bicycle/motorcycle or the oil tank of a motorcycle, and a flexible and shock-absorptive anti-slip layer fixedly arranged at the bottom side of each fastening belt for direct contact with the surface of the handlebars of the bicycle/motorcycle or the oil tank of the motorcycle in which the fastening unit is installed.

2. Description of the Related Art

Following fast development of technology, electronic communication technology has been greatly improved.

Nowadays, following the rise in living standards, mobile phone is popularly used. Almost everyone has a mobile phone in many countries. In addition to the basic function of communication, a smart phone is applicable for navigation, internet connection, video conference, music playing, game playing, and watching TV programs and video films. One may use a smart phone for data query when walking and sitting. However, a user is difficult to use a smart phone or tablet computer when riding a bicycle or motorcycle. As the history of smart phone and tablet computer is short, there is no commercial mobile electronic device holder practical for use in a bicycle or motorcycle to hold a smart phone or tablet computer for navigation or other purposes. Commercial mobile electronic device holders or racks are commonly designed for use in a car for holding smart phone or tablet computer for navigation or other purposes. As these mobile electronic device holders or racks have multiple joins, they cannot effectively absorb shocks and may be loosened or fall to the ground when used in a bicycle or motorcycle.

Therefore, there is a strong demand for a bicycle/motorcycle mobile electronic device holder, which is practical for use in a bicycle or motorcycle to hold a mobile electronic device, such as smart phone or tablet PC, for navigation or other purposes.

### SUMMARY OF THE INVENTION

The present invention has been accomplished under the circumstances in view. It is one object of the present invention to provide a bicycle/motorcycle mobile electronic device holder, which is practical for installation in the handlebars of a bicycle or motorcycle, the oil tank or a motorcycle, or the steering wheel of a car, for holding a mobile electronic device, such as smart phone or tablet computer, for navigation or other purposes.

It is another object of the present invention to provide a bicycle/motorcycle mobile electronic device holder, which has a flexible and shock-absorptive anti-slip pad provided at the bottom side of each fastening belt of the fastening unit thereof to enhance positioning stability after fastening of the fastening belts to the handlebars of a bicycle or motorcycle.

It is still another object of the present invention to provide a bicycle/motorcycle mobile electronic device holder, which has uses hook and loop material pads for detachably securing a mobile electronic device carrier to fastening belts of a fastening unit thereof, so that the user can detach the mobile electronic device carrier with the loaded smart phone from the fastening unit after leaving from the bicycle or motorcycle to which the fastening unit is fastened, preventing the smart phone from being stolen.

### BRIEF DESCRIPTION OF THE DRAWINGS

FIG. 1 is a perspective top elevational view of a bicycle/motorcycle mobile electronic device holder in accordance with the present invention.

FIG. 2 is a sectional view of the bicycle/motorcycle mobile electronic device holder in accordance with the present invention.

FIG. 3 is an applied view of the present invention, illustrating the bicycle/motorcycle mobile electronic device holder fastened to a bicycle and a smart phone carried in the bicycle/motorcycle mobile electronic device holder.

FIG. 4 is an exploded view, in an enlarged scale, of a part of the bicycle/motorcycle mobile electronic device holder in accordance with the present invention.

FIG. 5 is a perspective bottom elevational view, in an enlarged scale, of the bicycle/motorcycle mobile electronic device holder in accordance with present invention.

FIG. 6 is an exploded view of an alternate form of the bicycle/motorcycle mobile electronic device holder in accordance with the present invention.

FIG. 7 is an oblique bottom elevational view of the fastening unit shown in FIG. 6.

FIG. 8 corresponds to FIG. 7, illustrating an alternate form of the anti-slip layer.

FIG. 9 is a schematic drawing of one fastening belt in accordance with the present invention, illustrating the tail end of the fastening belt inserted through the buckle loop and turned backwards.

FIG. 10 is a schematic top applied view of the present invention, illustrating the installation of the bicycle/motorcycle mobile electronic device holder in the handlebars of a motorcycle.

FIG. 11 is an exploded view of an alternate form of the bicycle/motorcycle mobile electronic device holder in accordance with the present invention, illustrating a side-loading device of smart phone carrier.

FIG. 12 is a schematic applied view of the present invention, illustrating the bicycle/motorcycle mobile electronic device holder of FIG. 11 installed in the handlebars of a bicycle.

FIG. 13 illustrates another alternate form of the smart phone carrier in accordance with the present invention.

FIG. 14 is a schematic drawing illustrating the use of the smart phone carrier shown in FIG. 13.

FIG. 15 is a schematic applied view of the smart phone carrier shown of FIG. 13 in a bicycle.

FIG. 16 illustrates still another alternate form of the bicycle/motorcycle mobile electronic device holder used in a motorcycle to hold a tablet computer.

FIG. 17 is a schematic applied view of the invention, illustrating the fastening unit of the bicycle/motorcycle mobile electronic device holder configured to hold a tablet computer for installation in the steering wheel of a car.

FIG. 18 is a schematic sectional view of still another alternate form of the present invention, illustrating the installation of the fastening belts of the fastening unit of the bicycle/motorcycle mobile electronic device holder in a handlebar of a vehicle.

FIG. 19 is similar to FIG. 18, illustrating another fastening example of the fastening belts of the fastening unit.

FIG. 20 is a schematic applied view of the present invention, illustrating the tail ends of the fastening belts inserted through the respective buckle loops and then turned backwards and secured in place with the loop (or hook) material pads at the top side (outer side) of the tail ends fastened to the hook (or loop) material pads at the top side (outer side) of the respective fastening belts.

FIG. 21 is a schematic applied view of the present invention, illustrating the hook (or loop) material pads at the tail ends of the fastening belts directly attached to the loop (or hook) material pads at the bottom wall of the smart phone carrier after insertion of the respective tail ends through the respective buckle loops.

### DETAILED DESCRIPTION OF THE PREFERRED EMBODIMENT

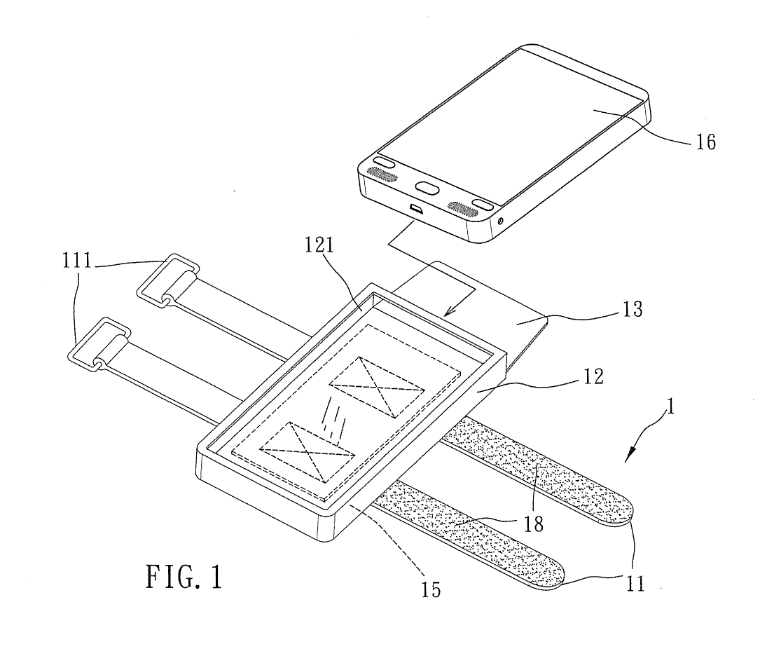

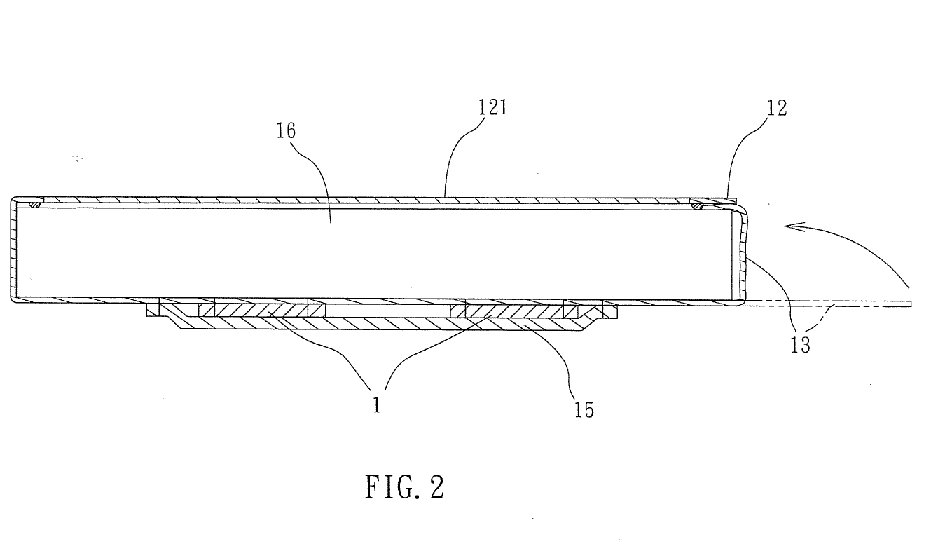

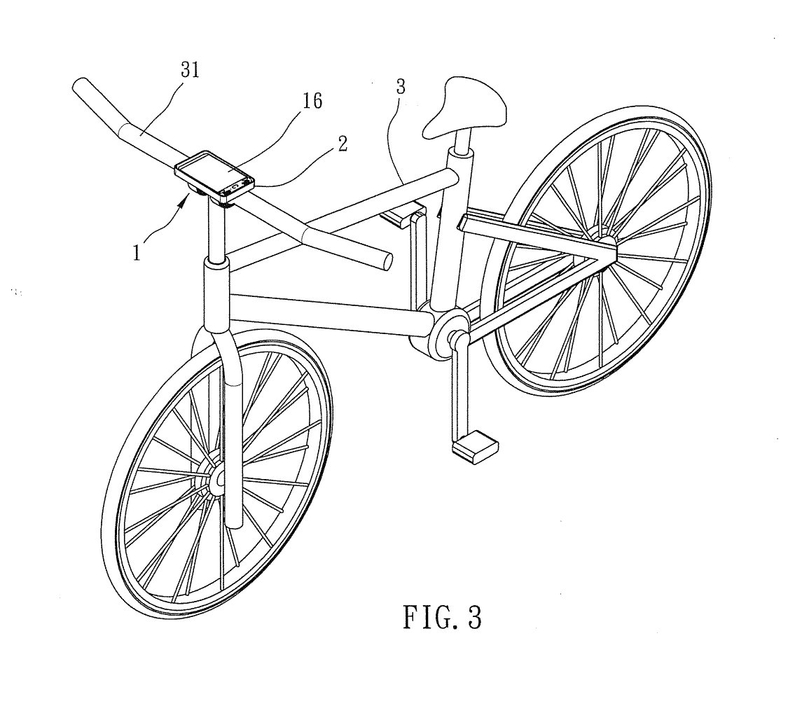

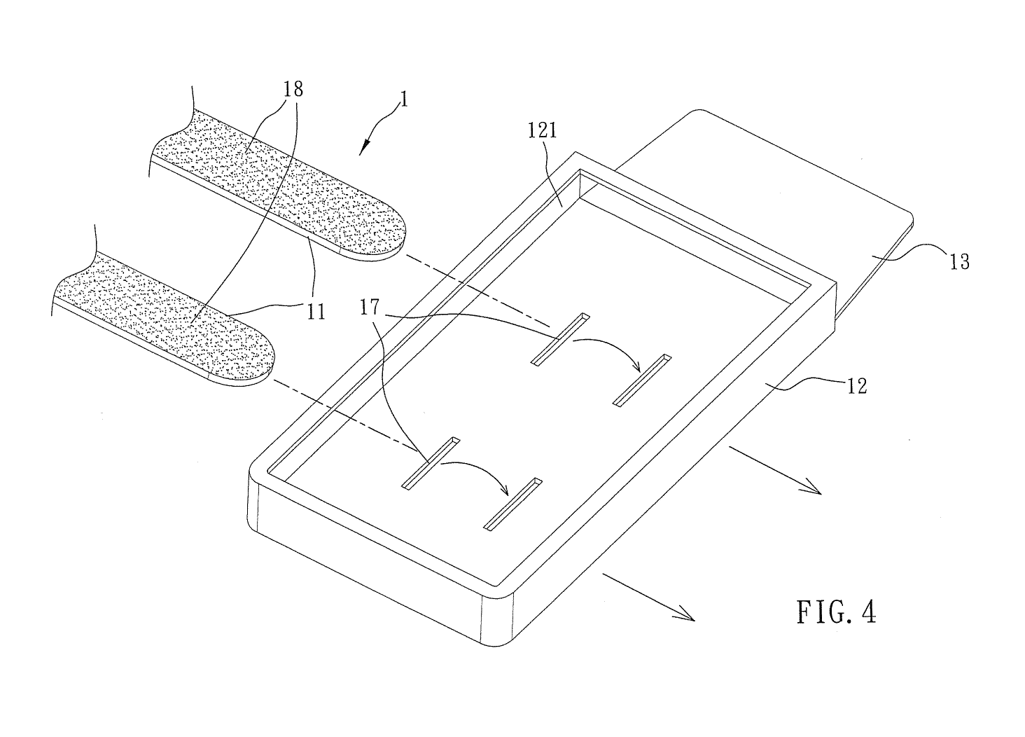

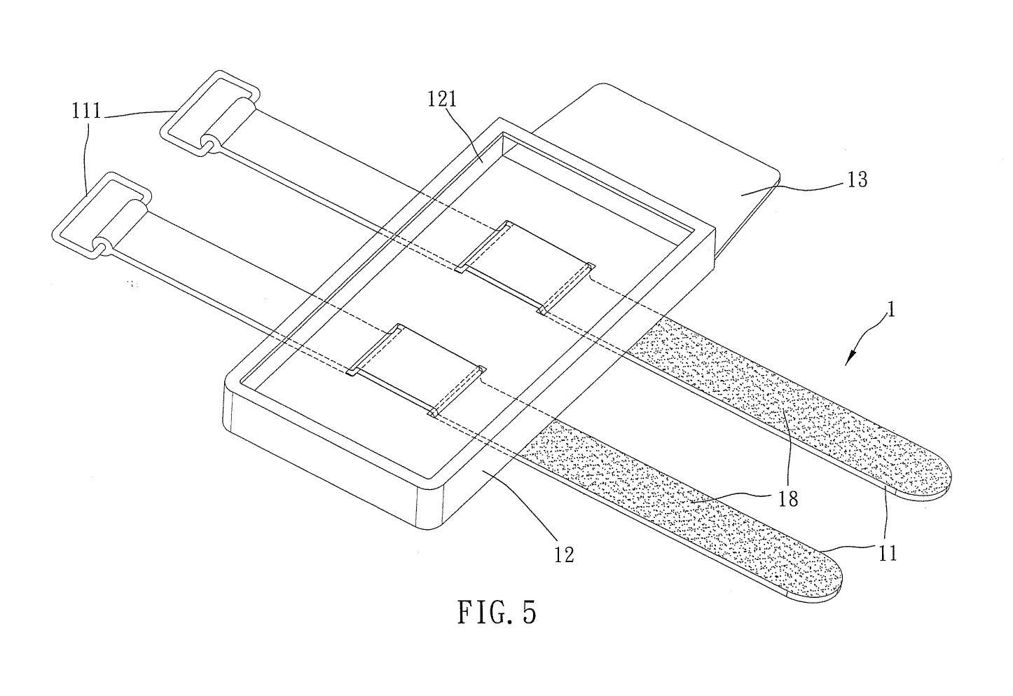

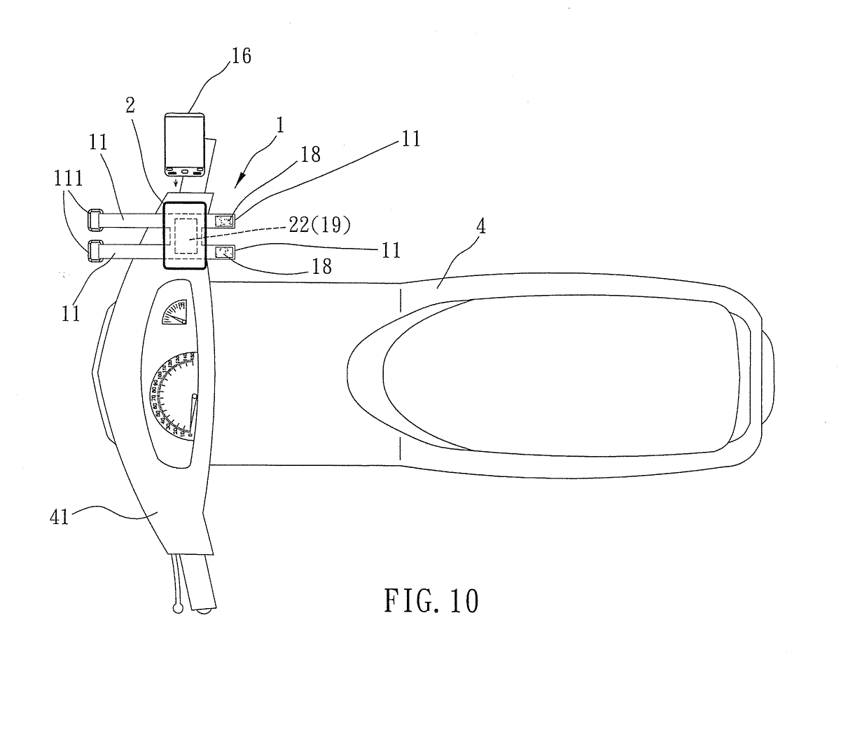

Referring to FIGS. 1 and 2, a bicycle/motorcycle mobile electronic device holder in accordance with the present invention is shown comprising a fastening unit 1 and a mobile electronic device carrier, for example, smart phone carrier 12. The fastening unit 1 comprises at least one, for example, two fastening belts 11 fastened to the bottom side of the smart phone carrier 12. The two ends of each fastening belt 11 can be joined together. Each fastening belt 11 has one end thereof provided with a buckle loop 111 and the other end thereof provided with hook and loop materials (Velcro) 18. According to this embodiment, the smart phone carrier 12 is a pocket, having an access hole defined in one end thereof and a cover flap 13 for closing the access hole. After insertion of a smart phone 16 through the access hole into the inside of the smart phone carrier 12, the cover flap 13 is turned upwards and then backwards to the inside of the smart phone carrier 12 to close the access hole, and then the fastening belts 11 are attached to the handlebars 31 of a bicycle 3 (see FIG. 3) or the handlebars 41 (or oil tank) of a motorcycle 4 (see FIG. 10) and then firmly secured thereto by means of the hook and loop materials (Velcro) 18. Thus, the smart phone 16 is firmly secured to the bicycle 3 or motorcycle 4 for navigation or other purposes. Further, the fastening unit 1 comprises a flexible and shock-absorptive anti-slip pad 15 provided at the bottom side of each fastening belt 11 to enhance positioning stability after fastening of the fastening belts 11 to the handlebars 31 of a bicycle 3 or the handlebars 41 (or oil tank) of a motorcycle 4. The smart phone carrier 12 further has an opening 121 (or transparent view window) on the top side thereof, and at least one, for example, two sets of insertion slots 17 for the insertion of the fastening belts 11 (see FIGS. 4 and 5).

Under pressure from the fastening belts 11 around the handlebars 31 of a bicycle 3 or the handlebars 41 (or oil tank) of a motorcycle 4, the physical structure of the soft layer underneath the fastening belts 11 will be transformed to reserve the tightening pressure. During riding, the shocking force of bicycle/motorcycle from bad road conditions might move the smart phone 16 or tablet computer 8 a little bit from its position. However, it will be instantly repositioned to its original position by the stress build-in the transformed soft layer at the bottom side of the fastening belts 11.

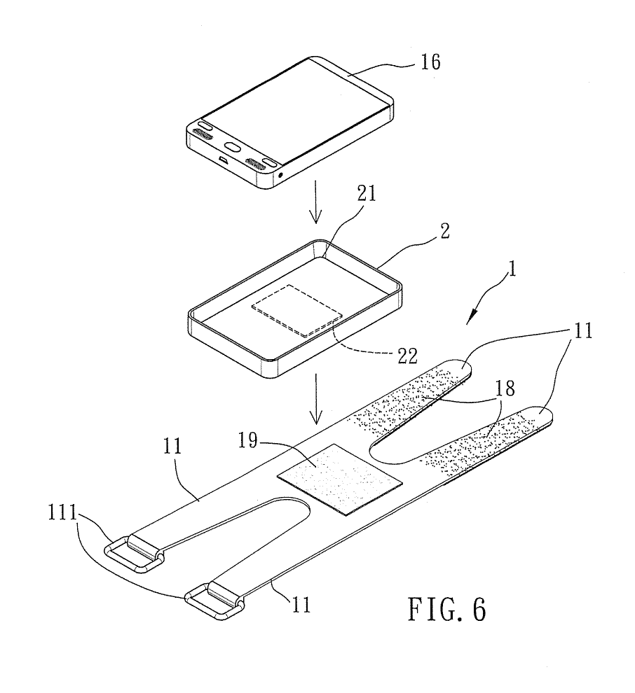

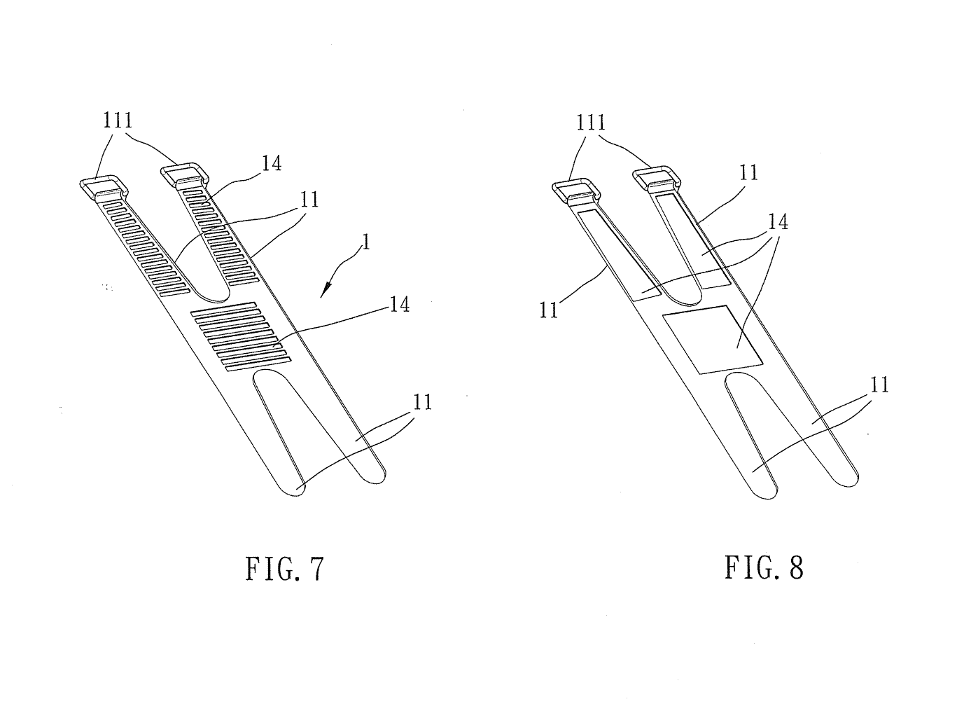

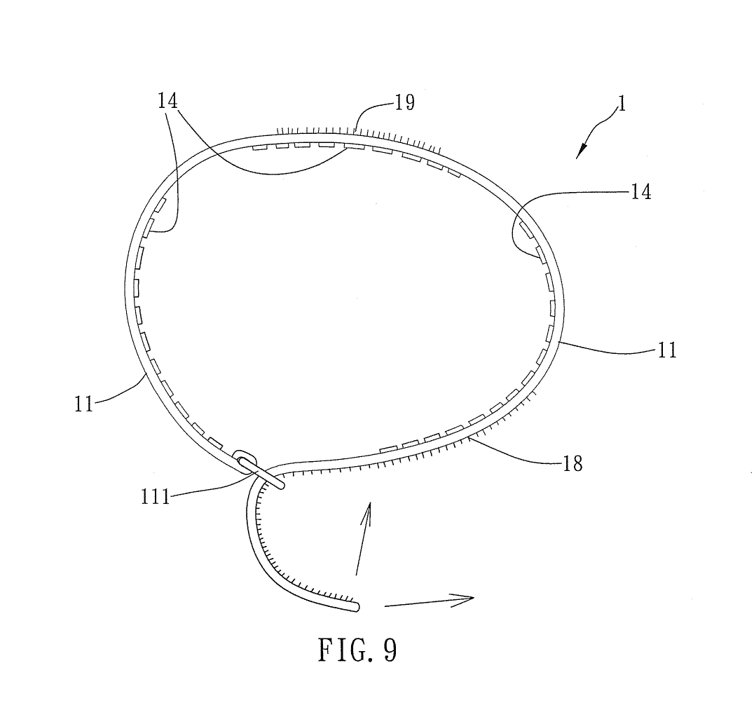

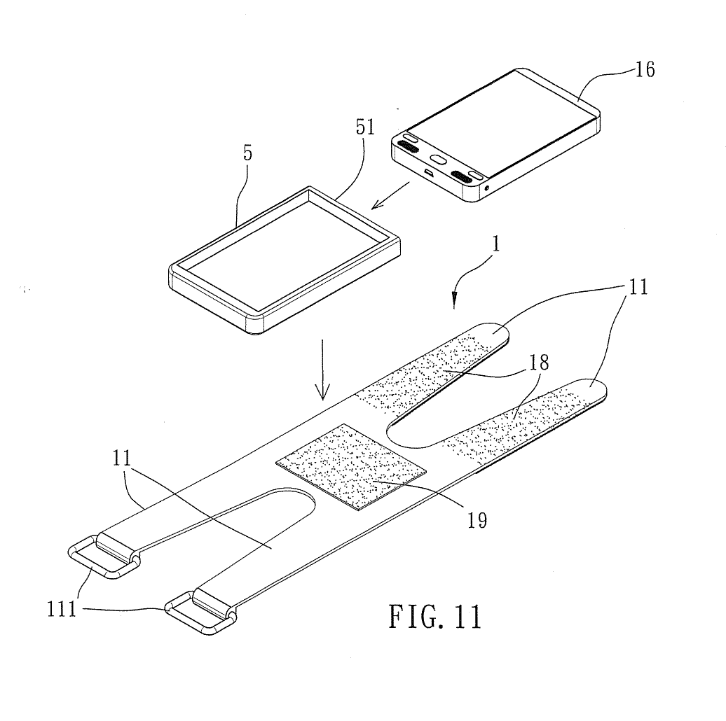

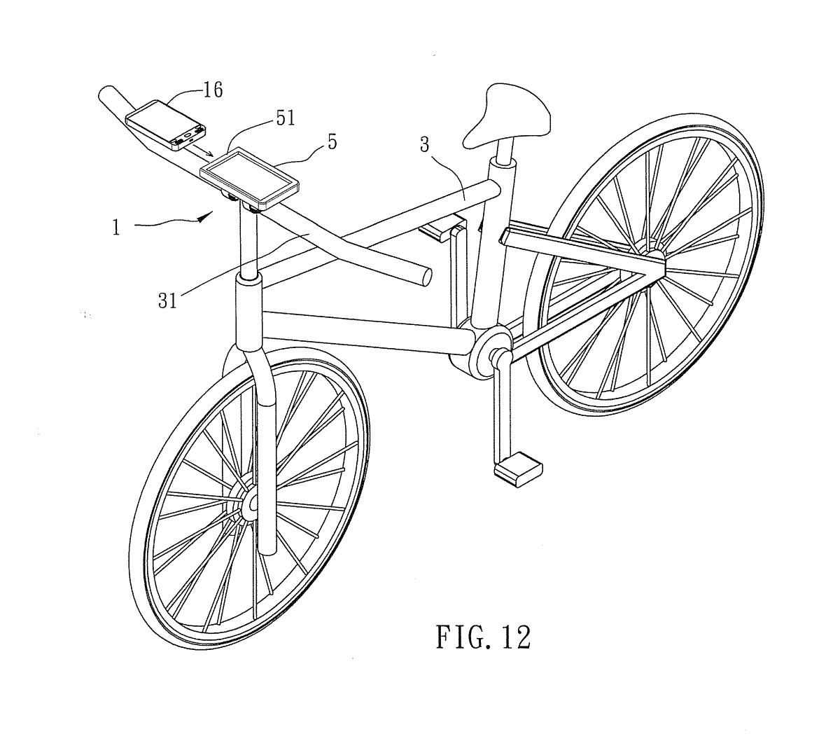

FIG. 6 illustrates an alternate form of the bicycle/motorcycle mobile electronic device holder in accordance with the present invention. According to this embodiment, the bicycle/motorcycle mobile electronic device holder comprises a fastening unit 1 and a smart phone carrier 2. The fastening unit 1 comprises at least one, for example, two fastening belts 11 fastened to the bottom side of the smart phone carrier 12. The two ends of each fastening belt 11 can be joined together. Each fastening belt 11 has one end thereof provided with a buckle 111 and the other end thereof provided with hook and loop materials (Velcro) 18. According to this second embodiment, the smart phone carrier 2 is a box defining a top opening 21. Further, the two fastening belts 11 have the middle parts thereof integrally joined together. Further, a pad of hook material (or loop material) 19 and a pad of loop material (or hook material) 22 are respectively fixedly located on the bottom side of the smart phone carrier 2 and the top side of the middle part of the fastening unit 1. By means of attaching the pad of hook material (or loop material) 19 to the pad of loop material (or hook material) 22, the smart phone carrier 2 is fastened to the fastening unit 1. By means of the hook and loop materials (Velcro) 18, the fastening belts 11 can be conveniently and firmly fastened to the handlebars 31 of a bicycle 3 (see FIG. 3) or the handlebars 41 (or oil tank) of a motorcycle 4 (see FIGS. 10 and 12). Thus, the smart phone 16 is firmly secured to the bicycle 3 or motorcycle 4 for navigation or other purposes. Further, the fastening unit 1 comprises a flexible and shock-absorptive anti-slip layer 14 of single piece or multi-piece design provided at the bottom side of the fastening belts 11 (see FIGS. 7 and 8) to enhance positioning stability after fastening of the fastening belts 11 to the handlebars 31 of a bicycle 3 or the handlebars 41 (or oil tank) of a motorcycle 4. Further, when fastening the fastening belts 11 to the handlebars 31 or 41 of a bicycle 3 or motorcycle 4, insert the end of the hook and loop materials (Velcro) 18 of each fastening belt 11 through the respective buckle loop 111 and then securing the hook material of the hook and loop materials (Velcro) 18 to the loop material thereof (see FIG. 9). Further, a side-loading design of smart phone carrier 5 having a side opening 51 (see FIGS. 11 and 12) may be used to substitute for the top-loading design of the smart phone carrier 2 with the top opening 21.

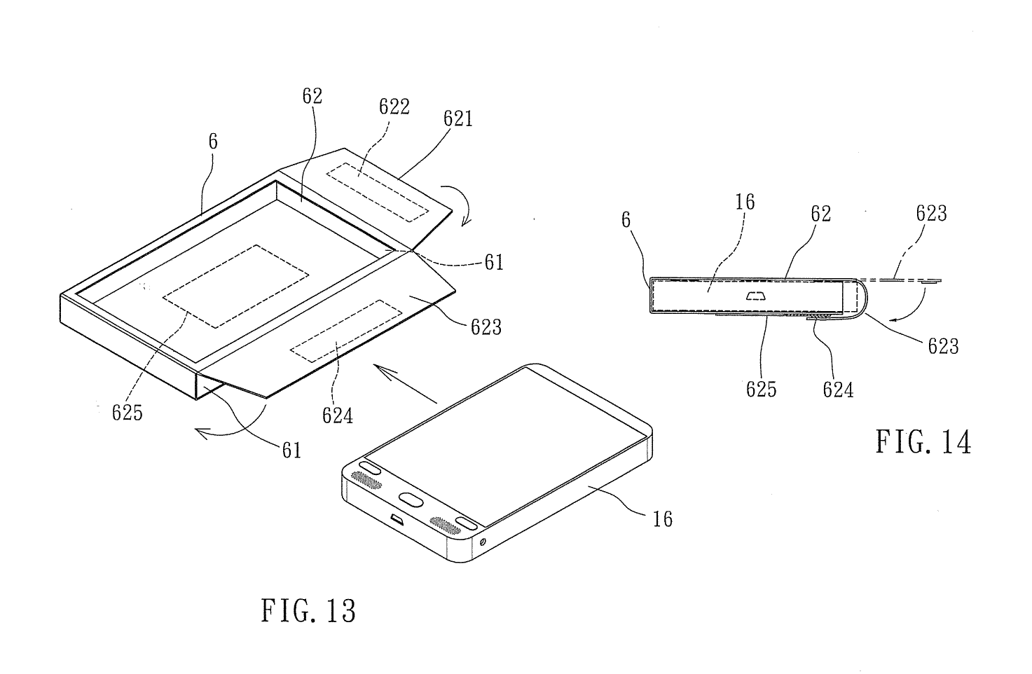

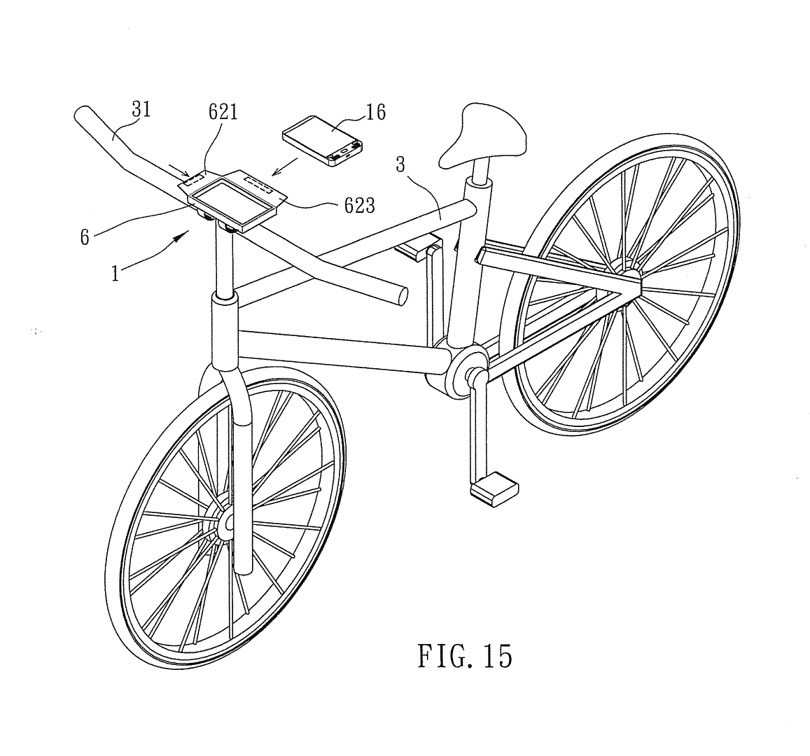

FIGS. 13-15 illustrate another alternate form of the bicycle/motorcycle mobile electronic device holder in accordance with the present invention. According to this embodiment, the smart phone carrier 6 can hold any of a variety of smart phones 16 of different sizes. According to this embodiment, the smart phone carrier 6 is a collapsible box having a top opening (or transparent view window) 62, two access holes 61 respectively defined in each of two adjacent lateral sides thereof, two cover flaps 621;623 respectively extended from the border edge of the top side thereof and adapted for covering the access holes 61, a hook material (or loop material) pad 625 located on the bottom side thereof, and two loop material (or hook material) pads 622;624 respectively located on the bottom sides of the cover flaps 621;623 and respectively fastenable to the hook material (or loop material) pad 625. When a smart phone 16 is inserted through one access hole 61 into the inside of the smart phone carrier 6, the cover flaps 621;623 are respectively turned downwards and then inserted into the inside of the access holes 61 to fasten the loop material (or hook material) pads 622;624 to the hook material (or loop material) pad 625, securing the smart phone 16 firmly in the smart phone carrier 6.

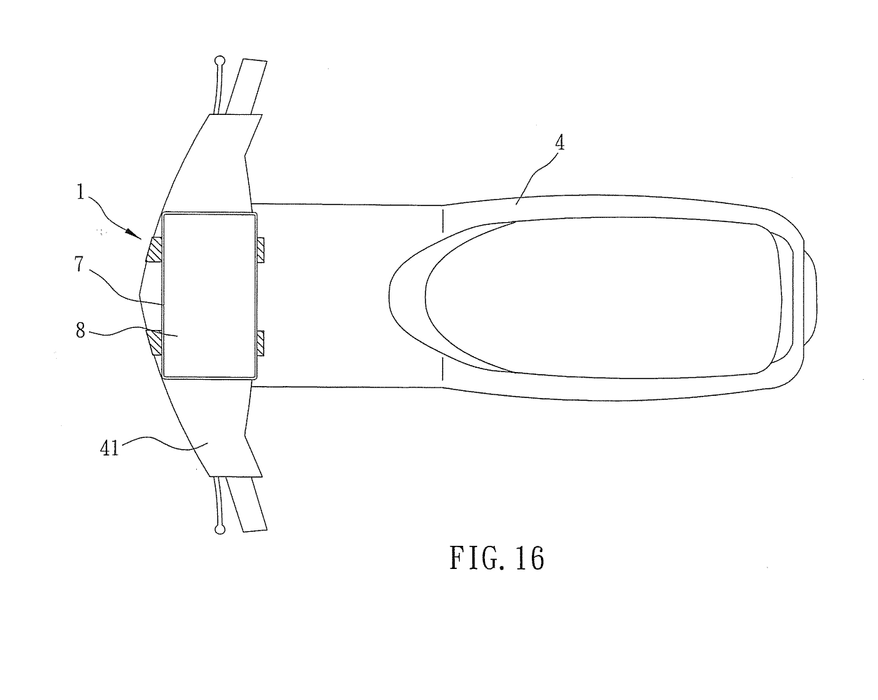

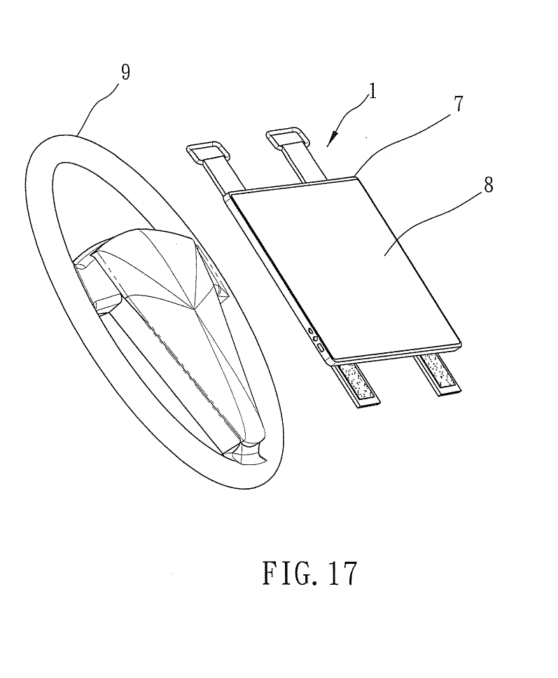

Further, the fastening unit 1 can also be used to fasten a tablet computer 8 to the handlebars 41 of a motorcycle 4, holding the tablet computer 8 on the top side of the motorcycle's speedometer for navigation, azimuth and speed display. The mobile electronic device carrier, referenced by 7 (see FIG. 16), is configured for holding a tablet computer 8, and the fastening unit 1 can be designed for fastening the carrier 7 to the steering wheel 9 of a car (see FIG. 17).

The handlebars 31 or 41 of different bicycles 3 or motorcycles 4 may have different designs. It is difficult to secure a planar object, such as smart phone 16 or tablet computer 8, to the multi-curve smooth surface of the handlebars 31 or 41 of a bicycle 3 or motorcycle 4. The fastening unit 1 of the invention design is so designed that each fastening belt 11 consists of an upper layer and a lower layer stitched or bonded together, wherein the upper layer is prepared by a material of tough, low extensibility and high flexibility, such as nylon; the lower layer that is prepared by a material of low extensibility and high flexibility with anti-slip capability, such as rubber, leather, synthetic leather or silicon rubber. Further, the lower layer of each fastening belt 11 has the bottom side thereof attached with an anti-slip layer 14.

The material of tough, low extensibility and high flexibility for the upper layer of each fastening belt 11 has a low coefficient of friction and may slip easily when directly used and fastened to the smooth surface of the handlebars 31 or 41 of a bicycle 3 or motorcycle 4.

The material of low extensibility and high flexibility with anti-slip capability for the upper layer of each fastening belt 11 is lowly extensible and may be stretched to extend its length easily, losing its fastening function.

By means of bonding the aforesaid two materials of different physical properties for use in the bicycle/motorcycle mobile electronic device holder, the fastening belts 11 can be positively fastened to the smooth surface of the handlebars 31 or 41 of a bicycle 3 or motorcycle 4, or the oil tank of a motorcycle 4, avoiding displacement or damaging the coating of the smooth surface of the handlebars or oil tank.

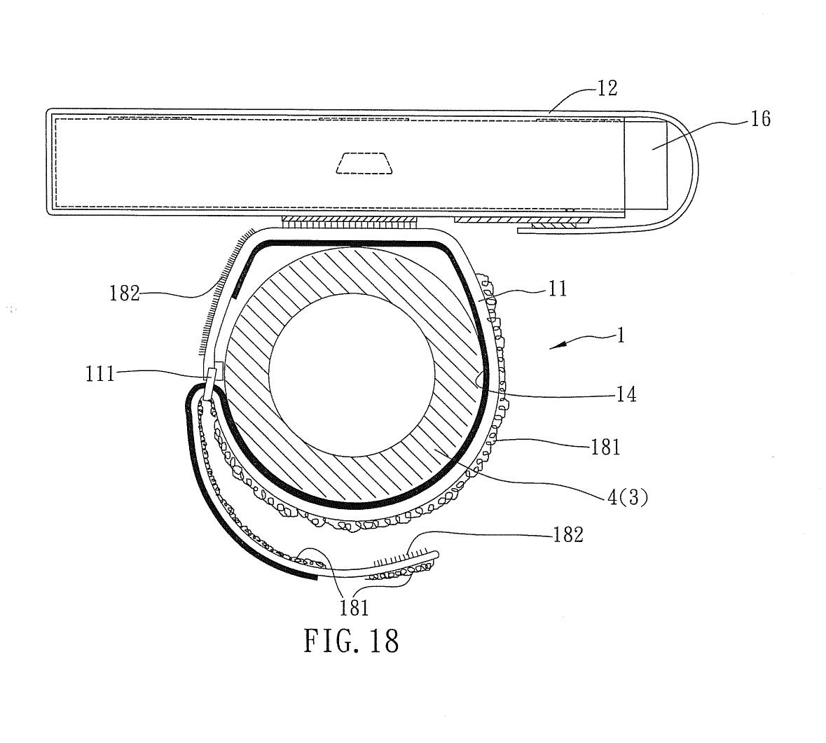

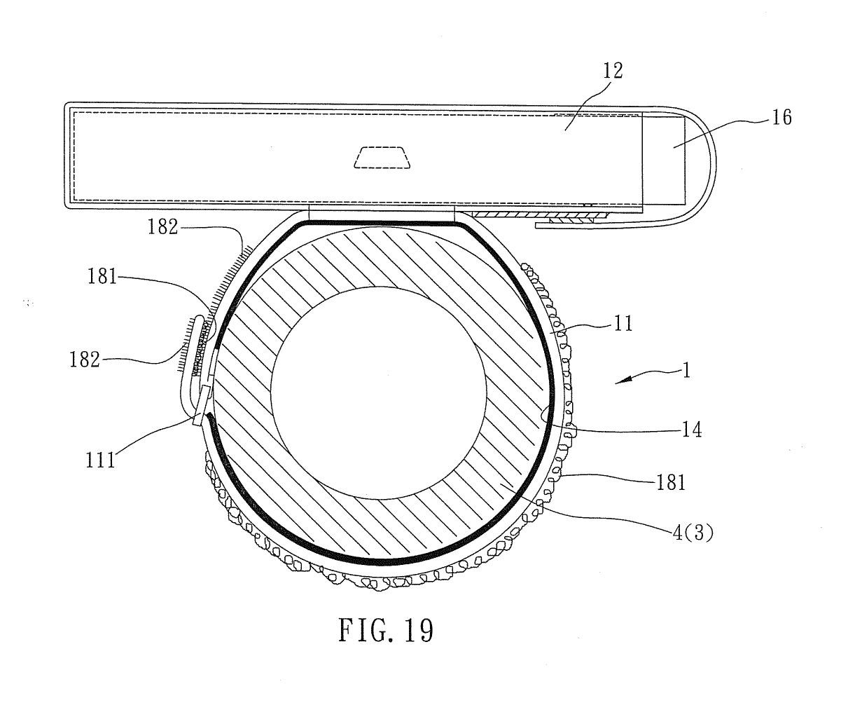

FIG. 18 illustrates still another alternate form of the fastening unit 1. According to this embodiment, hook (or loop) material pads 181 and loop (or hook) material pads 182 are respectively arranged on the opposing top and bottom sides of each of the fastening belt 11 near the ends thereof and other selected locations as well as the area near the buckle loop 111. After insertion of the tail ends of the fastening belts 11 through the respective buckle loops 111, the tail ends of the fastening belts 11 are turned backwards and then the respective hook (or loop) material pads 181 are respectively attached to the respective loop (or hook) material pads 182, and therefore the fastening belts 11 are firmly secured in position. When fastening the fastening belts 11 to the handlebars 31;41 or any other part of a larger size heavy bicycle 3 or motorcycle 4 where the tail ends of the fastening belts 11 cannot be turned backwards to have the respective hook (or loop) material pads 181 be respectively attached to the respective loop (or hook) material pads 182 after insertion of the respective tail ends through the respective buckle loops 111, the loop (or hook) material pads 182 at the tail ends of the fastening belts 11 can be respectively and directly attached to the hook (or loop) material pads 181 near the buckle loops 111 after insertion of the respective tail ends through the respective buckle loops 111. In this way, the fastening belts 11 are firmly fastened to the handlebars 31;41 or any other part of a larger size heavy bicycle 3 or motorcycle 4 (see FIG. 19).

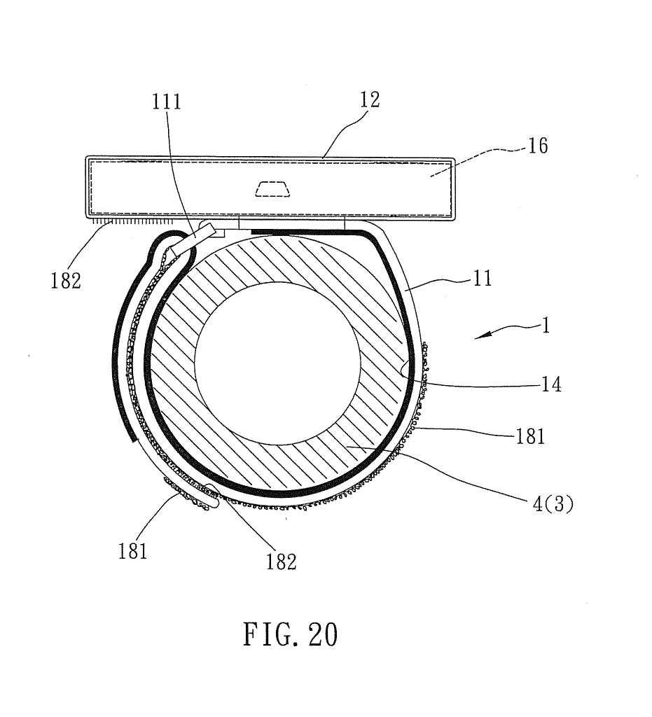

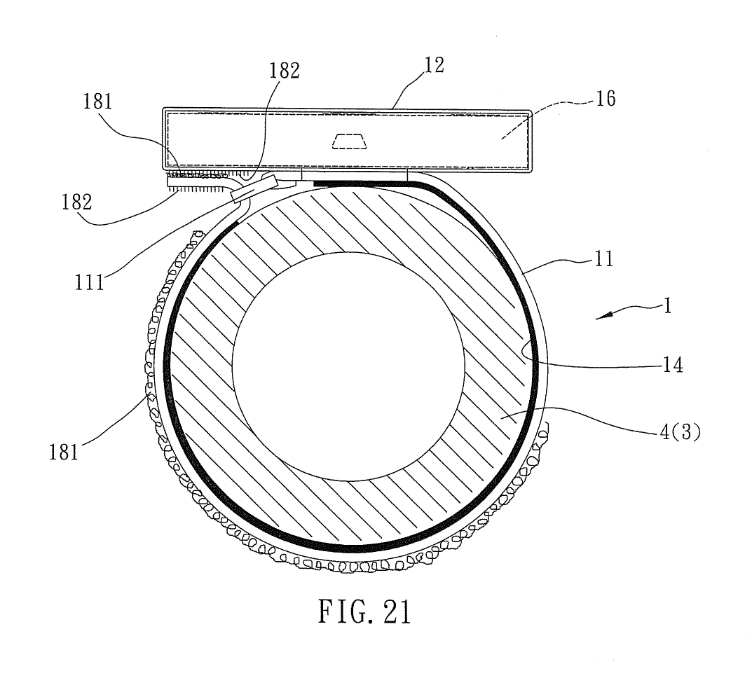

In still another alternate form of the present invention, as shown in FIG. 20, the bottom wall of the smart phone carrier 12 can be affixed to the fastening belts 11 near the buckle loops 111; hook (or loop) material pads 181 are arranged on the top side (outer side) of the fastening belts 11; loop (or hook) material pads 182 are arranged on the opposing top and bottom sides (inner and outer sides) of the fastening belts 11 near their tail ends and also arranged on the bottom wall of the smart phone carrier 12. After insertion of the tail ends of the fastening belts 11 through the respective buckle loops 111, the tail ends are turned backwards and then secured in place by attaching the loop (or hook) material pads 182 at the top side (outer side) of the tail ends to the hook (or loop) material pads 181 at the top side (outer side) of the respective fastening belts 11 (see FIG. 20). Alternatively, the hook (or loop) material pads 181 at the tail ends of the fastening belts 11 can be directly attached to the loop (or hook) material pads 182 at the bottom wall of the smart phone carrier 12 after insertion of the respective tail ends through the respective buckle loops 111 (see FIG. 21).

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A bicycle/motorcycle mobile electronic device holder, comprising:
a mobile electronic device carrier for holding a mobile electronic device, for example, a smart phone, for navigation or predetermined purposes, said mobile electronic device carrier comprising an access hole through which a mobile electronic device is insertable into the inside of said mobile electronic device;
a fastening unit, said fastening unit comprising at least one fastening belt affixed to a bottom side of said smart phone carrier for fastening said mobile electronic device carrier to the handlebars of a bicycle/motorcycle or the oil tank of a motorcycle, each said fastening belt comprising a plurality of hook and loop material pads arranged at opposing top and bottom sides thereof for joining opposing head and tail ends of the respective fastening belt to secure the respective fastening belt firmly to the handlebars of a bicycle/motorcycle or the oil tank of a motorcycle; and
a flexible and shock-absorptive anti-slip layer fixedly arranged at the bottom side of each said fastening belt for direct contact with the surface of the handlebars of the bicycle/motorcycle or the oil tank of the motorcycle in which said fastening unit is installed.

2. The bicycle/motorcycle mobile electronic device holder as claimed in claim 1, wherein each said fastening belt comprises an upper layer and a lower layer fixedly fastened together, said upper layer being prepared by a material of tough, low extensibility and high flexibility, such as nylon, said lower layer being prepared by a material of low extensibility and high flexibility with anti-slip capability, such as rubber, leather, synthetic leather or silicon rubber.

3. The bicycle/motorcycle mobile electronic device holder as claimed in claim 1, wherein each said fastening belt comprises a buckle loop located on the head end thereof for securing the tail end of the respective fastening belt.

4. The bicycle/motorcycle mobile electronic device holder as claimed in claim 1, wherein each said fastening belt comprises a buckle loop located on the head end thereof, hook material pads and loop material pads respectively arranged on the opposing top and bottom sides of each said fastening belt near the head and tail ends thereof and the area near the buckle loop, each said fastening belt being fastenable to the handlebars or a selected part of a bicycle/motorcycle in such a manner that after insertion of the tail end of each said fastening belts through the respective buckle loop, the tail end of the fastening belt is turned backwards and then the respective hook material pads are respectively attached to the respective buckle loop material pads to have the respective fastening belt be firmly secured in position.

5. The bicycle/motorcycle mobile electronic device holder as claimed in claim 1, wherein each said fastening belt comprises a buckle loop located on the head end thereof, hook material pads and loop material pads respectively arranged on the opposing top and bottom sides of each said fastening belt near the head and tail ends thereof and the area near the buckle loop, each said fastening belt being fastenable to the handlebars or a selected part of a bicycle/motorcycle in such a manner that the buckle loop material pads at the tail ends of the fastening belt are respectively and directly attached to the hook material pads near the buckle loop after insertion of the tail end of the respective fastening belt through the respective buckle loop.

6. A bicycle/motorcycle mobile electronic device holder, comprising:
a fastening unit, said fastening unit comprising at least one fastening belt fastenable to the handlebars of a bicycle/motorcycle or the oil tank of a motorcycle, each said fastening belt comprising a plurality of hook and loop material pads arranged at opposing top and bottom sides thereof for joining opposing head and tail ends of the respective fastening belt to secure the respective fastening belt firmly to the handlebars of a bicycle/motorcycle or the oil tank of a motorcycle;
a mobile electronic device carrier for holding a mobile electronic device, for example, a smart phone, for navigation or predetermined purposes, said mobile electronic device carrier comprising a loop and hook material pad located on a bottom side thereof and detachably fastenable to one hook and loop material pad on a middle part of the top side of each said fastening belt; and
a flexible and shock-absorptive anti-slip layer fixedly arranged at the bottom side of each said fastening belt for direct contact with the surface of the handlebars of the bicycle/motorcycle or the oil tank of the motorcycle in which said fastening unit is installed.

7. The bicycle/motorcycle mobile electronic device holder as claimed in claim 6, wherein each said fastening belt comprises an upper layer and a lower layer fixedly fastened together, said upper layer being prepared by a material of tough, low extensibility and high flexibility, such as nylon, said lower layer being prepared by a material of low extensibility and high flexibility with anti-slip capability, such as rubber, leather, synthetic leather or silicon rubber.

8. The bicycle/motorcycle mobile electronic device holder as claimed in claim 6, wherein said anti-slip layer is selectively made in a single piece or multi-piece design.

9. The bicycle/motorcycle mobile electronic device holder as claimed in claim 6, wherein said mobile electronic device carrier is configured to hold a tablet computer; said at least one fastening belt of said fastening unit is fastenable to the handlebars, oil tank or steering wheel of a vehicle.

10. A bicycle/motorcycle mobile electronic device holder, comprising:
a fastening unit, said fastening unit comprising at least one fastening belt fastenable to the handlebars of a bicycle/motorcycle or the oil tank of a motorcycle, each said fastening belt comprising a plurality of hook and loop material pads arranged at opposing top and bottom sides thereof for joining opposing head and tail ends of the respective fastening belt to secure the respective fastening belt firmly to the handlebars of a bicycle/motorcycle or the oil tank of a motorcycle and a hook and loop material pad located on a middle part of the top side thereof; and
a mobile electronic device carrier for holding a mobile electronic device for navigation or predetermined purposes, said mobile electronic device carrier being a collapsible box comprising a top opening located on a top side thereof, two access holes respectively defined in each of two adjacent lateral sides thereof, two cover flaps respectively extended from the border edge of the top side of said mobile electronic device carrier and adapted for covering said access holes, a hook material pad located on the bottom side of said mobile electronic device carrier, and two loop material pads respectively located on the bottom sides of the cover flaps and respectively fastenable to the hook material pad at said bottom side.
